(19) United States
(12) Patent Application Publication
(10) Pub. No.: US 2009/0202778 A1
(43) Pub. Date: Aug. 13, 2009

(54) Carpet Tile

(75) Inventor: Peggie D. McGee, Chattanooga, TN (US)

Correspondence Address: KILYK & BOWERSOX, P.L.L.C., 400 HOLIDAY COURT, SUITE 102, WARRENTON, VA, 20186, US

(73) Assignee: MANNINGTON MILLS, INC., Salem, NJ (US)

(21) Appl. No.: 12/366,191

(22) Filed: Feb. 5, 2009

Related U.S. Application Data
(60) Provisional application No. 61/027,051, filed on Feb. 8, 2008.

(51) Int. Cl. D03D 27/00; B32B 33/00

(52) U.S. Cl. 428/89

(57) ABSTRACT

A carpet and carpet tile are described which have a diverse set of patterns, figures or shapes along with a variety of color schemes arranged in various sections of the carpet. In embodiments, carpet tiles incorporating the shapes and color patterns as described herein can be assembled into a tiled flooring assembly, while also maintaining a consistent visual appearance. Other aspects of the present invention are also described.

### BACKGROUND OF THE PRESENT INVENTION

This application claims the benefit under 35 U.S.C. §119(e) of prior U.S. Provisional Patent Application No. 61/027,051, filed Feb. 8, 2008, which is incorporated in its entirety by reference herein.

The present invention relates to carpet and relates to a carpet tile containing a set of dissimilar patterns and colors which can be combined in a single installation while maintaining a consistent or pleasing visual effect.

In the commercial carpet market, certain customers and applications may require carpet containing a set of diverse patterns or shapes along with a variety of colors. Applications can include broadloom carpet installations. In certain other applications, the technique of installing a carpet surface using a side by side combination of comparatively small squares or tiles has been developed. However, in either broadloom carpet or carpet tile applications, the combination of a diverse set of figures, patterns or colors in the textile face of the carpet can result in a visually incongruous effect. This clashing effect can result, for example, from dissimilar patterns or shapes being placed side by side, or in the case of tiled applications, from the juxtaposition of tiles having different patterns, shapes, or colors directly next to each other in conflicting orientations.

Nevertheless, the carpet market still demands products and installations with multiple shapes or patterns, and/or installations in which a tiled installation is desired without relying on rigid tile arrangements that can require added workman time and cost, and that sacrifice a visually diverse effect. Accordingly, there is a need in the carpet industry to develop carpet designs and constructions and tile installation techniques that can incorporate multiple or diverse shapes, patterns, and colors, while maintaining a consistent or harmonious visual effect.

### SUMMARY OF THE PRESENT INVENTION

A feature of the present invention is to provide a carpet tile having a pattern or design incorporating a diverse set of patterns, figures or shapes along with a variety of color schemes, patterns or combinations, while maintaining a consistent visual effect.

A further feature of the present invention is to provide a carpet tile having a pattern or design incorporating a set of diverse shapes, figures, or patterns, along with a variety of colors, which can be used to create tiles that can be installed together side by side in a random or other orientation, while still maintaining a consistent visual effect.

Additional features and advantages of the present invention will be set forth in part in the description that follows, and in part will be apparent from the description, or may be learned by practice of the present invention. The objectives and other advantages of the present invention will be realized and attained by means of the elements and combinations particularly pointed out in the description and appended claims.

To achieve these and other advantages, and in accordance with the purposes of the present invention, as embodied and broadly described herein, the present invention relates to a carpet tile having a backing, a leading edge, a trailing edge opposite the leading edge, and a length extending from the leading edge to the trailing edge. The carpet tile can comprise a first plurality of sections. Each section of the first plurality of sections can have a width that is the same or different distance as the width of the other sections of the first plurality of sections. Each section of the first plurality of sections can have a length that is parallel to the length of the carpet tile and shorter than the length of the carpet tile. The first plurality of sections can comprise a first plurality of yarns and a second plurality of yarns. Each yarn of the first plurality of yarns can comprise a respective color scheme that differs from the color scheme of at least one of the other yarns of the first plurality of yarns. The first plurality of yarns can extend from the leading edge to the trailing edge. As an option, the first plurality of yarns can be all of the same color scheme. Each yarn of the first plurality of yarns can comprise a respective height, relative to the backing, that remains constant from the leading edge to the trailing edge. Each yarn of the second plurality of yarns can comprise a respective color scheme that differs from the color scheme of at least one of the other yarns of the second plurality of yarns. Each yarn of the second plurality of yarns can extend from the leading edge to the trailing edge. Each yarn of the second plurality of yarns can comprise two or more different heights, relative to the backing, from the leading edge to the trailing edge.

The carpet tile can comprise a second plurality of sections adjacent the first plurality of sections. Each section of the second plurality of sections can have a width that is perpendicular to the length of the carpet tile and that is the same or different distance as the width of the other sections of the second plurality of sections. Each section of the second plurality of sections can have a length that is parallel to the length of the carpet tile and shorter than the length of the carpet tile. The widths of the sections of one or more or all of the second plurality of sections can be smaller than the widths of the sections of the first plurality of sections. The second plurality of sections can comprise a third plurality of yarns and a fourth plurality of yarns. Each yarn of the third plurality of yarns can comprise a respective color scheme that differs from the color scheme of at least one of the other yarns of the third plurality of yarns. As an option, the third plurality of yarns can be all of the same color scheme. Each yarn of the third plurality of yarns can extend from the leading edge to the trailing edge. Each yarn of the third plurality of yarns has a respective height, relative to the backing, that remains constant from the leading edge to the trailing edge. Each yarn of the fourth plurality of yarns has a respective color scheme that differs from the color scheme of at least one of the other yarns of the fourth plurality of yarns. Each yarn of the fourth plurality of yarns can extend from the leading edge to the trailing edge. Each yarn of the fourth plurality of yarns can have two or more different heights, relative to the backing, from the leading edge to the trailing edge.

Two of the fourth plurality of yarns can optionally comprise the same color scheme as two of the first plurality of yarns. Two of the third plurality of yarns can optionally have the same color scheme as two of the second plurality of yarns. The “color schemes” of each of the yarns on the carpet tile can be within 20% of each other based on the Munsell value scale. Each section of the first plurality of sections and each section of the second plurality of sections can comprise one rectangular shape or can comprise other shapes. The first, second, third, and fourth plurality of yarns can have a combined total of three or more different color schemes of yarn (such as three, four, five, six, seven, eight, or more).

Each adjacent set of shapes can be distinct or different from an adjacent set of shapes. While the sets of shapes embedded or constructed in the carpet are visually distinct, a coherent or continuous visual effect can be achieved due, in one regard, to the continuity or blending effect between color regions.

The present invention further relates to a series of carpet tiles formed from the carpet having a series of shapes constructed in color schemes or color patterns as described above.

It is to be understood that both the foregoing general description and the following detailed description are exemplary and explanatory only and are intended to provide a further explanation of the present invention as claimed.

The accompanying drawings, which are incorporated and constitute a part of the present application, show aspects of the present invention and together with the description serve to explain one or more principles of the present invention.

### BRIEF DESCRIPTION OF THE DRAWINGS

FIG. 1 is a drawing of a carpet tile constructed according to at least one embodiment of the present invention, incorporating a first plurality of sections and a second plurality of sections arranged adjacent to the first plurality of sections.

FIG. 2 is a drawing representing a segment of the first plurality of sections and the second plurality of sections of the carpet tile according to at least one embodiment of the present invention.

FIG. 3 is a drawing representing a segment of the third plurality of sections and the fourth plurality of sections of the carpet tile according to at least one embodiment of the present invention.

FIGS. 4A-D are computer-generated carpet designs of the present invention in black/white showing different color yarn creating various patterns based on color yarn and tufting height.

FIG. 5 is a chart representing tufting order of yarns, including yarns which are visible (capital letters) and yarns which are not visible due to being tufted tight against the substrate (lowercase letters).

### DETAILED DESCRIPTION OF THE PRESENT INVENTION

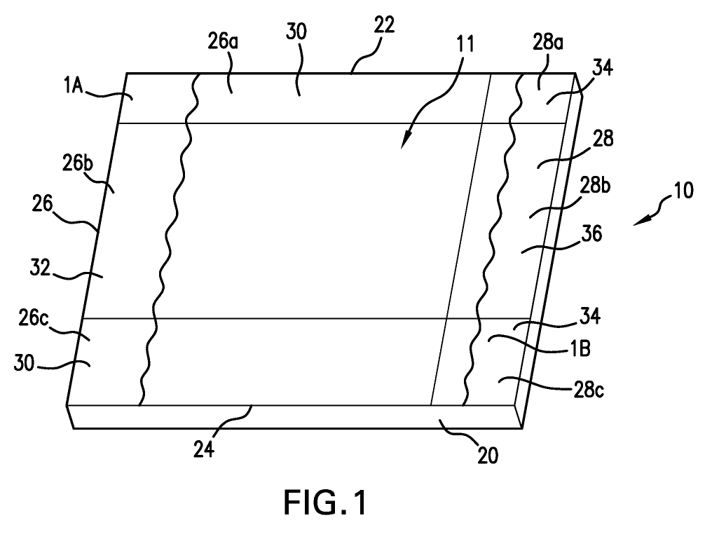

The present invention relates to a carpet tile, generally designated as 10 (for instance, in FIG. 1) in the drawings, that incorporates a set of color patterns to define a series of sections. The carpet tile can be installed in broadloom or tiled form, while maintaining a visually coherent or consistent appearance. When carpet tiles 10 fabricated according to one or more embodiments of the present invention are combined to provide a modular flooring installation, it may be noted that it is not necessary to arrange the individual carpet tiles 10 in a specific orientation to achieve a visually consistent effect. It is instead possible (though optional) to arrange the carpet tiles 10 in a regular or an irregular or random orientation, while still preserving the continuity of the visual impression.

For purposes of the present invention, a section of the carpet tile 10 can comprise a shape, figure, and/or pattern associated with one or more color schemes or color patterns. It should also be understood that the reference to color (observed visually) is generally with respect to the color of yarns that are visually seen on top of the textile face (the surface walked on by a person). A yarn can comprise one color or can be a combination of at least two different colored yarns. For purposes of this invention, it should be understood that the Munsell value scale is a known numerical system to depict the light and darkness of colors or light and darkness of neutral colors. This value scale is also sometimes referred to as the Gray value scale. However, any known method of color classification can be used. Some exemplary color classification methods are Munsell method, L.A.B. method, and grayscale method. For purposes of present invention and for illustration purposes only, the present invention refers to Munsell method of color classification; however, other methods of color classification can alternatively or also be used.

Numerous sets of shapes, figures, patterns, and color patterns can be incorporated in a broadloom, carpet tile, or tile assembly without causing a visually incongruous or clashing effect.

The carpet tile 10 (including embodiments illustrated in FIGS. 1, 2, and 3) can comprise one or more layers of a backing material 20, a leading edge 22, a trailing edge 24 opposite the leading edge 22, and a length extending from the leading edge 22 to the trailing edge 24 and defined by the distance from the leading edge 22 to the trailing edge 24.

For purposes of the present invention, the carpet tile 10 of the present invention can be of any suitable shape and dimension. Although generally illustrated in a square shape, carpet tile 10 can have other shapes, such as rectangles, diamonds, and other shapes. The carpet tile 10 can be or form a carpet of any dimensions as described elsewhere herein, 12 inch, 18 inch, 36 inch, 6 ft. wide, 12 ft. wide, broadloom carpet, woven carpet, wall to wall and the like. Essentially, any type of carpet can be formed. The carpet tile 10 can also be considered or can comprise a textile substrate. Also, the yarn or other material used to form the carpet 10 can be considered textile fibers. The yarn or textile fibers can define a fibrous face or nap, which comprises the walking surface of the carpet tile. The yarn or textile fibers are secured to the backing material by tufting, stitching, bonding, adhesive, or any other suitable means. The yarn or fibers can be natural or synthetic, can be any length and have any size, and can be any brand or type used to form carpets (e.g., twisted ply yarn, single strand, multi-colored, dyed solution, skein-dyed, or piece-dyed).

The carpet tile 10 can comprise a first plurality of sections 26 and a second plurality of sections 28 that is adjacent to the first plurality of sections. The first plurality of sections 26 can comprise two or more sections, encountered along a strip or section in a machine direction of the carpet tile 10. The first plurality of sections 26 can comprise a first section 26a, a second section 26b, and optionally a third section 26c. The second plurality of sections 28 can comprise two or more sections encountered along a strip or section in a machine direction of the carpet tile 10. The second plurality of sections 28 can comprise a fourth section 28a, a fifth section 28b, and optionally a sixth section 28c. Each section of the first plurality of sections 26 can have a width that is perpendicular to the length of the carpet tile 10 and that is the same distance as the width of the other sections of the first plurality of sections 26. Each section of the second plurality of sections 28 can have a width that is perpendicular to the length of the carpet tile 10 and that is the same distance as the width of the other sections of the second plurality of sections 28. The length of each section can be parallel to the length of the carpet tile 10 and can be shorter than the length of the carpet tile.

The first plurality of sections 26 and the second plurality of sections 28 can each be a set or series of distinct sections associated with distinct color patterns (e.g., appearances). Adjacent sections of the first plurality of sections 26 alternate between a first color pattern 30 and a second color pattern 32, which is different from the first color pattern 30. Thus, and as will be discussed more fully below, the first section 26a can comprise the first color pattern 30. The second section 26b can comprise the second color pattern 32. The third section 26c can comprise the first color pattern 30.

Adjacent sections of the second plurality of sections 28 alternate between a third color pattern 34 and a fourth color pattern 36, which is different from the third color pattern 34. Thus, and as will be discussed more fully below, the fourth section 28a can comprise the third color pattern 34. The fifth section 28b can comprise the fourth color pattern 36. The sixth section 28c can comprise the third color pattern 34. The particular color patterns can provide a continuity of visual effect or impression even while the sections, shapes, figures or patterns constructed in the carpet tile change.

The color pattern in each section can define at least one shape, figure, or pattern. The color patterns in each section define shapes, figures or patterns in the textile face or nap of carpet tile 20. As illustrated in FIG. 1, the shapes, figures, or patterns can include, for instance, a set of rectangular shapes 11. For purposes of the present invention, any shape can be formed in each of the plurality of sections used herein and the present invention is not limited to the particular shapes identified herein. Any number of shapes of any size can be formed in each of the plurality of sections used herein. Thus, for instance, the “first plurality of sections” can be or constitute shapes of the same or different dimensions which can be intermixed, overlap each other (e.g., partially) or follow each other sequentially or be in any other arrangement. This is also true for all other sections (e.g., “second plurality of sections”).

The carpet tile 10 along with the embedded sets of sections, shapes, or figures can be produced using known production techniques, including, for instance, tufting, stitching, or otherwise embedding the backing material with yarns in a linear or machine direction. In other words, the color patterns can, for example, be defined by runs of colored fiber or yarn in a machine direction of carpet tile 10. According to embodiments, the distance from the top of the yarn to the backing material of tufting substrate or the degree that the yarn is tufted into the substrate or backing material defines a yarn height. The carpet tile 10 can comprise yarns with different heights relative to the backing. The yarns of greater height can be seen on the textile face, while yarns of lesser height cannot.

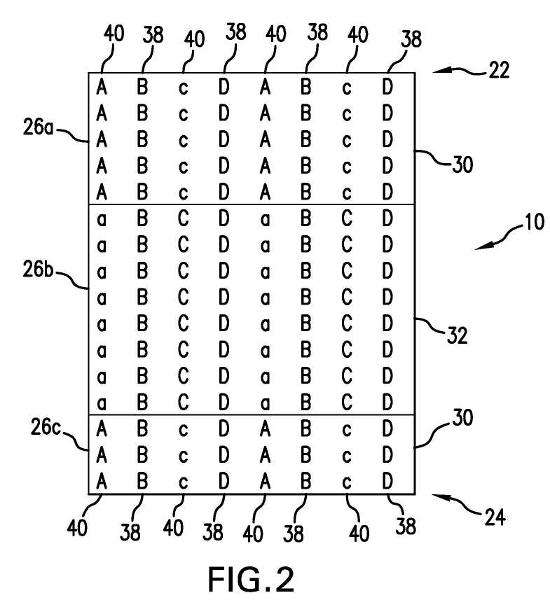

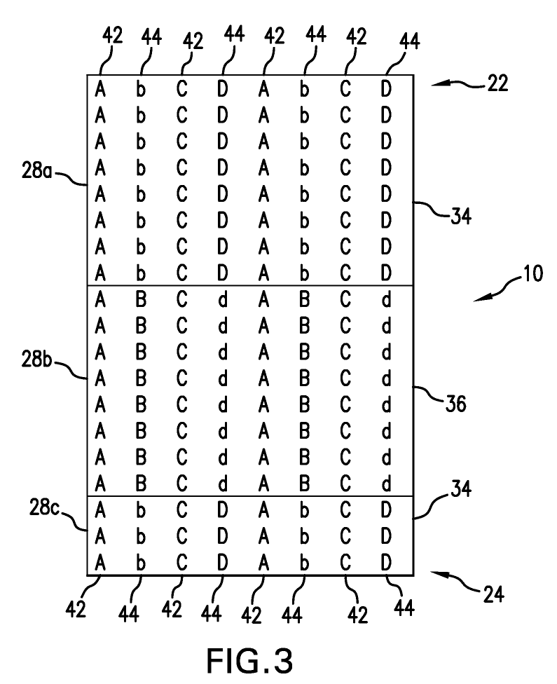

FIGS. 2-3 further depict examples of the color patterns that can be associated with each section of carpet tile 10 according to embodiments of the present invention. The color patterns of the carpet tile 10 are constructed of three or more colors, such as four colors (though more or less than four colors can be used). As used herein and represented in the drawings, the letters “A, B, C, and D” each represent yarns of a different color (or appearance). For example, “A” can represent a yarn that is brown, “B” can represent a yarn that is a combination of blue and yellow twisted or ply yarns, “C” can represent a yarn that is a combination of green and brown twisted or ply yarns, and “D” can represent a yarn that is turquoise. It should be understood that lower case letters, “a, b, c, d” are used in the drawings to indicate that a yarn of a particular color, while present on the carpet tile 10, is lower (i.e., tufted tight against the substrate) than the other yarns relative to the backing 20, and is therefore, not visible on the face of the carpet tile 10. The capital letters, A, B, C, D, are used in the drawings to represent yarns that have a higher yarn height than lower case letters and would be visible. As an option, each of the colors incorporated in the carpet tile 10 can be within 20% of each other based on the Munsell scale. For example, each of the colors incorporated in the carpet can be the same or within 5%, 10%, 15%, or 20% of each other based on the Munsell value scale. Each of the colors of yarns can be different in intensity, such as greater than 20% of each other based on the Munsell scale. As an option, at least one of the colors in the carpet tile 10 can be more than 20% different from the other colors present on the carpet tile, based on the Munsell scale.

As depicted in FIG. 2, the first color pattern 30 and the second color pattern 32 can comprise a first plurality of yarns 38 and a second plurality of yarns 40. As is shown and for exemplary purposes only, the first plurality of yarns is represented by the letters B and D, while second plurality of yarns is represented by the letters C and A. Both the first plurality of yarns 38 and the second plurality of yarns 40 can extend from the leading edge 22 to the trailing edge 24 of the carpet tile 10. Each yarn of the first plurality of yarns 38 can have a color or color scheme that differs from the color or color scheme of at least one of the other yarns of the first plurality of yarns. Though, as stated, as an option, the color or color scheme can be the same for each yarn in the first plurality of yarns. The first plurality of yarns 38 are provided at a constant height, relative to the backing. The first plurality of yarns 38 are always exposed or visible on the face of the carpet tile 10. The first plurality of yarns can comprise one or two different colors or color schemes or more than two different colors or color schemes.

As further depicted in FIG. 2, each yarn of the second plurality of yarns 40 can have a respective color scheme that differs from the color scheme of the first plurality of yarns 38. Each yarn of the second plurality of yarns 40 can have a color scheme that differs from at least one of the other yarns of the second plurality of yarns 40. Each yarn of the second plurality of yarns 40 can be provided at two or more different heights, relative to the backing 20. The two or more different heights of the second plurality of yarns 40 can comprise a first or elevated height at which the yarns can be seen on the face of the carpet tile and a second or lower height at which the yarns cannot be seen on the face of the carpet tile. The elevated height can be the same height as the “constant height” referenced above for the first plurality of yarns. The second plurality of yarns can comprise yarns of two different colors or color schemes. According to further embodiments, when one color of the second plurality of yarns 40 is visible in a particular section on the face of the carpet tile, the other color is not.

As is shown in FIG. 2, and exemplary only, the first (visual) color pattern 30 can comprise colors A,B,D (as observed from viewing the top of the carpet) and the second color pattern 32 can comprise the colors B,C,D. The first color pattern 30 and the second pattern 32 each define different rectangular shapes, as is more clearly depicted in FIG. 1.

As represented in FIG. 3, the second plurality of sections 28 can comprise a third plurality of yarns 42(A,C) and a fourth plurality of yarns 44 (B,D). The third plurality of yarns can optionally be one color or color scheme. As shown in FIG. 3, the third plurality of yarns 42 can be represented by the letters A and C, and the fourth plurality of yarns can be represented by the letters B and D. Both the third plurality of yarns 42 and the fourth plurality of yarns 44 can extend from the leading edge 22 to the trailing edge 24 of the carpet tile 10. Each yarn of the third plurality of yarns 42 can have a color or color scheme that differs from the color or color scheme of at least one of the other yarns of the third plurality of yarns 42. The third plurality of yarns 42 can be provided at a constant height, relative to the backing 20. The third plurality of yarns 42 are always exposed or visible on the face of the carpet tile 10. The third plurality of yarns 42 can comprise one or two or more different colors or color schemes.

As further depicted in FIG. 3, each yarn of the fourth plurality of yarns 44 can have a respective color scheme that differs from the color scheme of at least one of the other yarns of the fourth plurality of yarns 44. Each yarn of the fourth plurality of yarns 44 can be provided at two or more different heights, relative to the backing 10. The two or more different heights of the fourth plurality of yarns 44 can comprise a first or elevated height at which the yarns can be seen on the face of the carpet tile 10 and a second or lower height at which the yarns cannot be seen on the face of the carpet tile 10. Again, the “elevated height” can be the same height as the “constant height” of the first plurality of yarns. The fourth plurality of yarns 44 can comprise yarns of two different colors or color schemes. As an option, when one color of the fourth plurality of yarns 44 is visible in a section on the face of the carpet tile 10, the other color is not.

As shown in FIG. 3, the third color pattern can comprise colors A,C,D and the fourth color pattern can comprise colors A,B,C. Each color pattern can define different rectangular shapes. The first plurality of sections can alternate between the first color pattern (A,B,D) 20 and the second color pattern (B,C,D) 22, while the second plurality of sections can alternate between the third color pattern (A,C,D) 24 and the fourth color pattern (A,B,C). This pattern can be repeated for any width and/or length of the carpet.

Two of the fourth plurality of yarns 44 can have the same color or color scheme as two of the first plurality of yarns 38. Two of the third plurality of yarns 42 can have the same color or color scheme as two of the second plurality of yarns 40. The width of the sections of the second plurality of sections 28 can be smaller than the width of the sections of the first plurality of sections 26.

A carpet tile 10 that is 18 in.×18 in. or 24 in.×24 in. can comprise six distinct rectangular shapes, as shown in FIG. 1. The tile can comprise less than or more than six shapes, such as two, three, four, five, seven, eight, nine, ten, or more shapes. A series of tiles can have tiles with the same number or different number of shapes/sections. It will be appreciated that although FIG. 1 shows in one regard an illustrative set of six distinct rectangular shapes or design patterns embedded in recurring color patterns, other numbers or sizes of shapes, figures, or patterns, and/or other sequences, repetitions or arrangements of shapes, figures, or patterns can be used. For instance, less than or more than six shapes can be used in the design, such as four, five, six, seven, eight, nine, ten, or more shapes can be used. A carpet tile 10 incorporating the set of six distinct shapes, figures, or patterns as illustrated can include a set of those same six shapes in a different, alternating, randomized, or otherwise rearranged order or other arrangement.

When carpet tiles cut or fabricated according to the present invention are combined to provide a modular flooring installation, it may be noted that it is not necessary to arrange the individual carpet tiles in a specific orientation to achieve a visually consistent effect. As an option, it is possible to arrange the carpet tiles in an irregular or random orientation, while still preserving the continuity of the visual impression. Installation time and workman training can therefore be reduced. Floor coverings may also be installed as a combination of broadloom carpet and carpet tiles, as desired. Also, solid color tiles or other carpet tile designs can be randomly or non-randomly placed amongst the carpet tiles of the present invention.

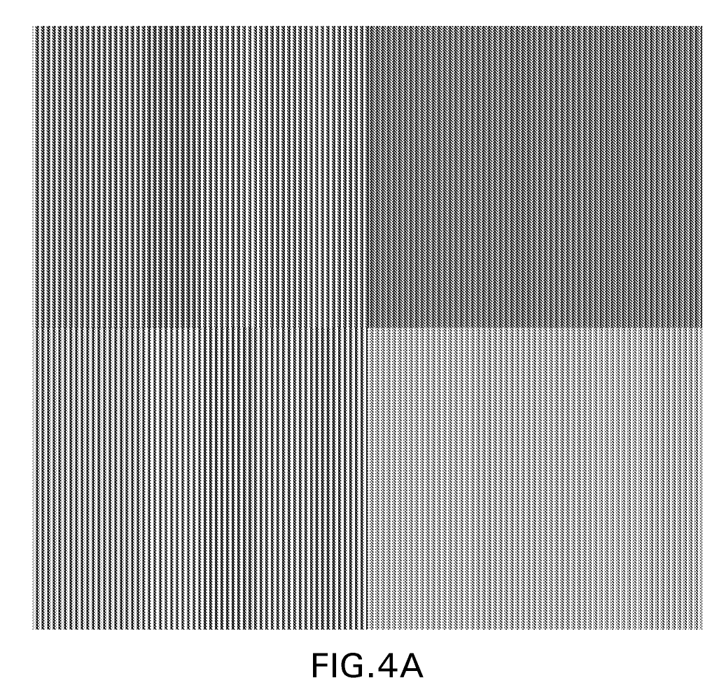

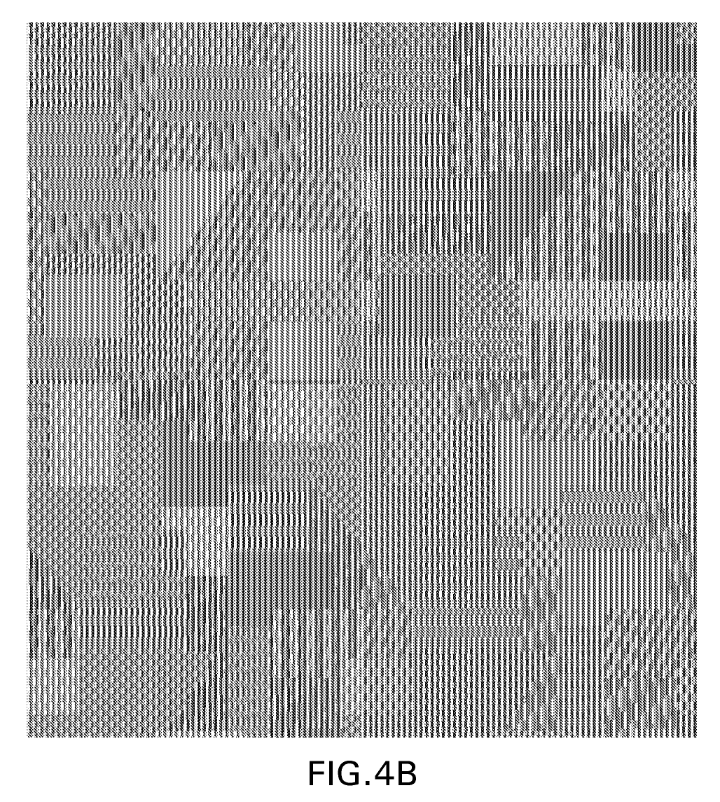

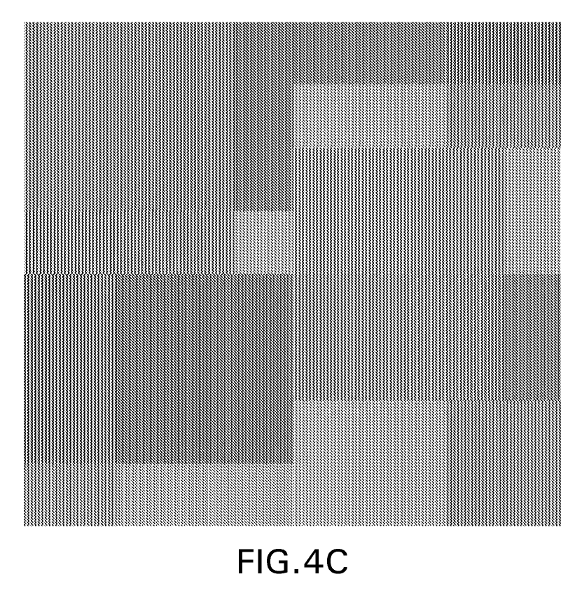

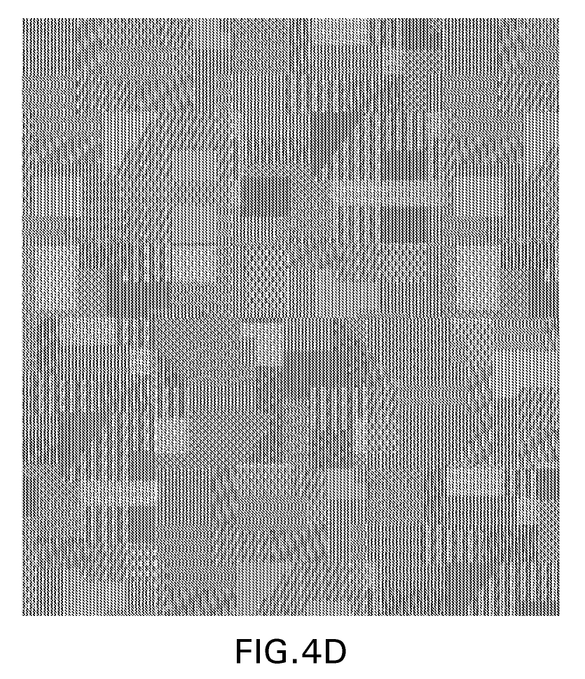

FIGS. 4A and 4B illustrate carpet webs having a pattern in accordance with the present invention. The web may be partitioned into individual carpet tiles. The pattern produced on the web defines shapes, figures or patterns which appear randomly positioned. The shapes can be rectangular and have any color(s). Carpet tiles of different shapes or sizes can be assembled together. It may be noted and as illustrated in FIGS. 4C and 4D, while a diverse visual appearance is created, the orientation of individual carpet tiles can be readily observed. Again, the carpet tiles can be installed in an irregular or randomized pattern without detracting from the visual effect. A tiled installation can also make repair of the floored surface more convenient since, among other things, one or a small number of carpet tiles that have been damaged or soiled can be individually replaced.

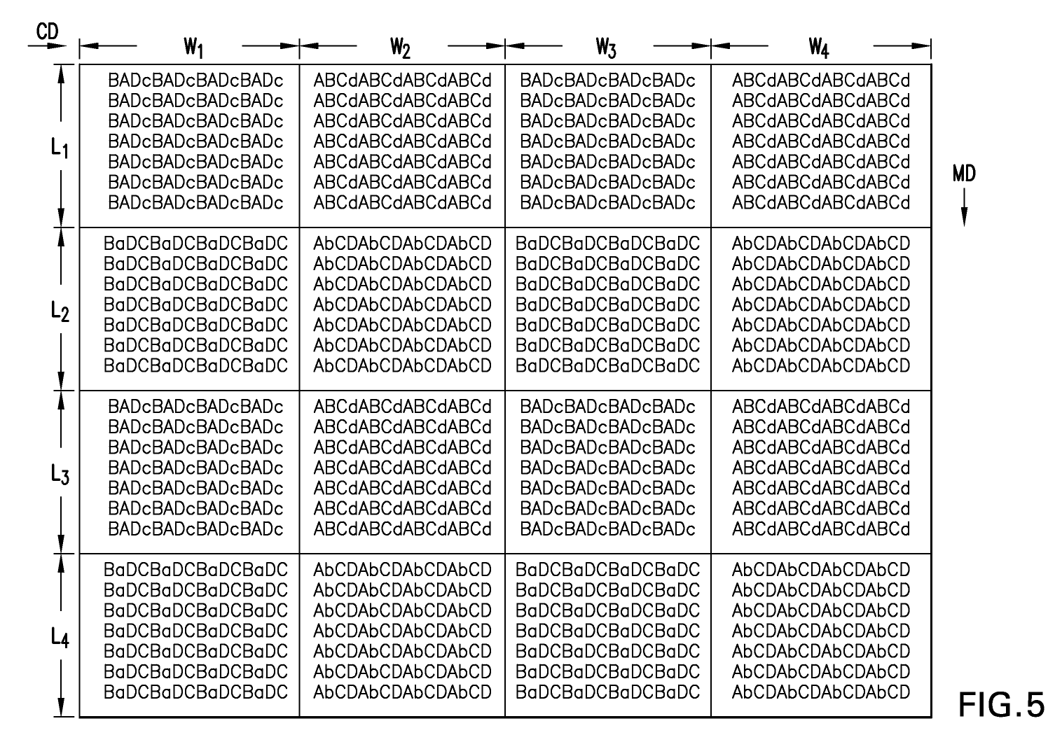

The threading of the tufting bars used to tuft the yarn into the web or substrate can comprise at least three or at least four different colors or types of yarn which, for purposes of discussion can be designated as yarns A-D. An example of a needle thread up is provided below:
BACK BAR B-D-B-D-B-D-B-D-A-C-A-C-A-C-A-C
FRONT BAR A-C-A-C-A-C-A-C-B-D-B-D-B-D-B-D
   Each letter represents a yarn threaded onto a needle on a back bar or front bar. With regard to the back bar, the repeating of B-D can be any length such as 18 inches, 12 inches, 36 inches, and the like. Preferably, the repeat is 18 inches. Similarly, the repeating of yarn A-C in the back bar can be the same repeating length in the back bar. Preferably, the back bar will maintain the same tufting height into the carpet substrate throughout the carpet web. Preferably, the tufting back bar will maintain the highest yarn height on the carpet web. Thus, the yarns in the back bar will be visible throughout the entire machine direction of the carpet. With respect to the front bar shown above, the yarns A-C repeat for a length such as 18 inches, 12 inches, 36 inches, and the like. Then, the yarns B-D repeat and the repeat length can be the same or different as the repeat length of yarns A-C in the front bar. The front bar is positioned so that the tufting of these yarns is in between the yarns threaded up into the back bar. The height of the tufting from the yarns of the front bar can be high or low and will be controlled such that one of yarns A or C will be tufted low and the other yarn tufted so that it has a high yarn height typically equivalent with the yarn height of the yarns from the back bar whereas the other yarn in the front bar will be tufted low so it is not initially visible. Thus, the yarns of the front bar will alternate with respect to being tufted low or not and therefore determine their visibility. An example of this type of tufting arrangement is shown in FIG. 5. In FIG. 5, the letters in capital letters are tufted to have a high yarn height and therefore be visible to an observer whereas the letters in lower case are yarns tufted low against the substrate and therefore would essentially be not visible or not visible at all. The L₁-L₄ can be any length and can be the same or different from each other. L₁-L₄ can be a length of 12 inches, 18 inches, 36 inches, 48 inches, 72 inches, and the like. W₁-W₄ represent the cross direction of the carpet web and W₁-W₄ can be the same or different to each other with respect to width. The width can be anywhere from 6 inches to 12 inches to 36 inches or higher. The number of Ws, while being shown as W₁-₄ can be any number such as W₁-W₆, W₇, W₈, W₉, W₁₀, and higher. Similarly, while FIG. 4 shows L₁-L₄, the number of Ls can be any number such as up to L₅, L₆, L₇, L₈, L₉, L₁₀ and higher. The gaps between each of W₁-W₄ and L₁-L₄ would not be present in the carpet, but is shown here just for ease of showing the pattern changes. Each of yarns A-D as shown can be the exact same yarns, can be yarns from the different lots, or can be yarns that are different in color, texture, or structure, or composition. The distance between needles in the back bar can be 5/32 inch, and can be distances greater or less than this. The distance between the needles in the front bar can be 5/32 inch and can be greater or smaller than this distance. Thus, the distance between each yarn can be 5/64 inch once tufted into the carpet substrate though this tufting distance can be greater or smaller such as from ⅕ to 1/20. Preferably the same colors (when having the same color-letter designation) are used for the front and back bar. As an option, and preferably, there is no middle height with respect to the tufting of the yarns into the substrate either the yarns are high for visibility or tufted tight so that they are not visible.

Further examples of tufting arrangements are provided below. The threading of the needle bars used to tuft the yarn into the web can comprise at least three colors and up to eight colors, wherein each letter denotes a different color or type of yarn.

### EXAMPLE#1

### 3 Colors

Back Bar: B-B-B-B-B-B-B-B-A-C-A-C-A-C-A-C
Front Bar: B-A-B-A-B-A-B-C-A-B-A-B-A-B-A-B

### EXAMPLE#2

### 3 Colors

Back Bar: B-A-B-A-B-A-B-A-C-A-C-A-C-A-C-A
Front Bar: B-A-B-A-B-A-B-A-B-A-B-A-B-A-B-A

### EXAMPLE#3

### 5 Colors

Back Bar: B-D-B-D-B-D-B-D-A-C-A-C-A-C-A-C
Front Bar: A-C-A-C-A-C-A-C-A-E-A-E-A-E-A-E

### EXAMPLE#4

### 6 Colors

Back Bar: B-D-B-D-B-D-B-D-A-C-A-C-A-C-A-C
Front Bar: A-C-E-C-A-C-E-C-B-F-B-D-B-F-B-D

### EXAMPLE#5

### 7 Colors

Back Bar: A-C-A-C-A-C-A-C-B-D-B-D-B-D-B-D
Front Bar: E-F-E-F-E-F-E-F-G-C-G-C-G-C-G-C

### EXAMPLE#6

### 8 Colors

Back Bar: B-D-B-D-B-D-B-D-A-C-A-C-A-C-A-C
Front Bar: A-C-E-F-A-C-E-F-B-D-G-H-B-D-G-H

As an option, the carpet can have a minimum of three or a minimum of four background colors that are visible in the carpet or carpet tile or each carpet tile. Furthermore, as an option, in the carpet or carpet tile or each carpet tile, at least three of the four colors or types of yarn are visible in any part of the carpet tile (e.g., within a square inch). As an option, when three colors are only used in the threading of the needle bars, at least two of three colors or types of yarn are visible in any part of the carpet tile (e.g., within a square inch).

With respect to the other variables typically present in a yarn pattern, the stitch rate per inch, the pile height, the weight, the type of primary backing, the pattern/shift, the secondary backing, and any other layers used to form a carpet are not critical to the present invention. Any of these variables can be selected in forming the carpet of the present invention and these various variables are conventionally known by those skilled in the art.

Any stitch rate can be used in the present invention, using any types of machines, such as a tufting machine. For example, the present invention can be tufted on a 1/10″ gauge tufting machine, but can also be tufted on other gauge machines, such as from about ½″ to about 1/20″ gauge machines. The stitch rate on the 1/10″ gauge construction is about 11 stitches per inch, but can also range from about 5 stitches to about 20 stitches or higher per inch. Preferably, the carpet of the present invention is a carpet tile and more preferably an 18″×18″ modular tile or 24″×24″ modular tile. The face of the carpet can be tufted, bonded, or woven, can be cut pile or looped, and the like.

FIG. 4A and FIG. 4B are simulated or computer-generated black and white carpet designs which reflect in gray scale different color yarn and tufting height. The various designs created as shown in FIG. 4A and FIG. 4B reflect various shapes and patterns that can be created using the patterns and tufting order described in the present invention. It is noted that FIG. 4A and FIG. 4B are representative of a 36″×36″ design, which can be repeated any number of times across the cross-direction of the web design. For instance, this 36″×36″ design can be repeated one, two, three, four, five, or six or more times in the cross-direction to create the width of the overall carpet web which ultimately will be cut into carpet tile sections. Preferably, the carpet tile is cut into 24″×24″ sections and by doing so, a variety of different tiles will be created that can then be used to form a surface covering in any type of pattern orientation, such as a random orientation. The length of the web, meaning the machine direction of the web, can be any length and will essentially repeat the carpet pattern shown in FIG. 4A or FIG. 4B. FIG. 4C and FIG. 4D are simulated or computer-generated black and white carpet designs showing four cut tiles placed together to form a surface covering thereby showing the ability to achieve a carpet tile having a pattern or design incorporating a set of diverse shapes, figures, or patterns along with a variety of color, which permits the tiles to be installed together side-by-side in a random or other orientation while still maintaining a consistent visual effect. The floor tiles shown in FIG. 4C and FIG. 4D are 24″×2441 tiles put next to each other in a random orientation.

Thus, the present invention includes a carpet tile comprising a backing; a leading edge; a trailing edge opposite the leading edge; a length extending from the leading edge to the trailing edge and defined by the distance from the leading edge to the trailing edge; a first plurality of sections, each section of the first plurality of sections having a width that is perpendicular to the length of the carpet tile and that is the same distance as the width of the other sections of the first plurality of sections, and each section having a length that is parallel to the length of the carpet tile and shorter than the length of the carpet tile, wherein, the first plurality of sections comprises a first plurality of yarns, each yarn of the first plurality of yarns having a respective color scheme that optionally differs from the color scheme of at least one of the other yarns of the first plurality of yarns, each yarn of the first plurality of yarns extending from the leading edge to the trailing edge, each yarn of the first plurality of yarns having a respective height, relative to the backing, that remains constant from the leading edge to the trailing edge, and a second plurality of yarns, each yarn of the second plurality of yarns having a respective color scheme that differs from the color scheme of at least one of the other yarns of the second plurality of yarns, each yarn of the second plurality of yarns extending from the leading edge to the trailing edge, each yarn of the second plurality of yarns having two or more different heights, relative to the backing, from the leading edge to the trailing edge; a second plurality of sections adjacent the first plurality of sections, each section of the second plurality of sections having a width that is perpendicular to the length of the carpet tile and that is the same distance as the width of the other sections of the second plurality of sections, and each section of the second plurality of sections having a length that is parallel to the length of the carpet tile and shorter than the length of the carpet tile, wherein the widths of the sections of the second plurality of sections is different from the widths of the sections of the first plurality of sections, wherein the second plurality of sections comprises a third plurality of yarns, each yarn of the third plurality of yarns having a respective color scheme that optionally differs from the color scheme of at least one of the other yarns of the third plurality of yarns, each yarn of the third plurality of yarns extending from the leading edge to the trailing edge, each yarn of the third plurality of yarns having a respective height, relative to the backing, that remains constant from the leading edge to the trailing edge; and a fourth plurality of yarns, each yarn of the fourth plurality of yarns having a respective color scheme that differs from the color scheme of at least one of the other yarns of the fourth plurality of yarns, each yarn of the fourth plurality of yarns extending from the leading edge to the trailing edge, each yarn of the fourth plurality of yarns having two or more different heights, relative to the backing, from the leading edge to the trailing edge; wherein two of the fourth plurality of yarns have the same color scheme as two of the first plurality of yarns; and wherein each of the color schemes are optionally within 20% of each other based on the Munsell scale.

Also, the present invention includes a carpet tile comprising a backing; a leading edge; a trailing edge opposite the leading edge; a length extending from the leading edge to the trailing edge and defined by the distance from the leading edge to the trailing edge; and a first plurality of sections, each section of the first plurality of sections having a width that is perpendicular to the length of the carpet tile and that is the same distance as the width of the other sections of the first plurality of sections, and each section having a length that is parallel to the length of the carpet tile and shorter than the length of the carpet tile, wherein, the first plurality of sections comprises a first plurality of yarns, each yarn of the first plurality of yarns having a respective color scheme that optionally differs from the color scheme of at least one of the other yarns of the first plurality of yarns, each yarn of the first plurality of yarns extending from the leading edge to the trailing edge, each yarn of the first plurality of yarns having a respective height, relative to the backing, that remains constant from the leading edge to the trailing edge, and a second plurality of yarns, each yarn of the second plurality of yarns having a respective color scheme that differs from the color scheme of at least one of the other yarns of the second plurality of yarns, each yarn of the second plurality of yarns extending from the leading edge to the trailing edge, each yarn of the second plurality of yarns having two or more different heights, relative to the backing, from the leading edge to the trailing edge.

The first plurality of yarns can comprise two different color schemes. The second plurality of yarns can comprise two different color schemes. The carpet tile can further comprise a second plurality of sections adjacent the first plurality of sections, each section of the second plurality of sections having a width that is perpendicular to the length of the carpet tile and that is the same distance as the width of the other sections of the second plurality of sections, and each section of the second plurality of sections having a length that is parallel to the length of the carpet tile and shorter than the length of the carpet tile, wherein the widths of the sections of the second plurality of sections is different from the widths of the sections of the first plurality of sections.

The second plurality of sections can comprise: a third plurality of yarns, each yarn of the third plurality of yarns having a respective color scheme that optionally differs from the color scheme of at least one of the other yarns of the third plurality of yarns, each yarn of the third plurality of yarns extending from the leading edge to the trailing edge, each yarn of the third plurality of yarns having a respective height, relative to the backing, that remains constant from the leading edge to the trailing edge; and a fourth plurality of yarns, each yarn of the fourth plurality of yarns having a respective color scheme that differs from the color scheme of at least one of the other yarns of the fourth plurality of yarns, each yarn of the fourth plurality of yarns extending from the leading edge to the trailing edge, each yarn of the fourth plurality of yarns having two or more different heights, relative to the backing, from the leading edge to the trailing edge.

Two of the fourth plurality of yarns can have the same color scheme as two of the first plurality of yarns. Two of the third plurality of yarns can have the same color scheme as two of the second plurality of yarns. The width of the sections of the second plurality of sections can be smaller than the width of the sections of the first plurality of sections. Each section of the first plurality of sections and each section of the second plurality of sections can comprise one rectangular shape. One of the yarns of the first plurality of yarns can comprise a combination of at least two different colored yarns. One of the yarns of the second plurality of yarns can comprise a combination of at least two different colored yarns. The first plurality of yarns can comprise a yarn that is brown and a yarn that is a combination of blue and yellow yarns. The second plurality of yarns can comprise a yarn that is turquoise and a yarn that is a combination of green and brown yarns. One of the yarns of the third plurality of yarns can comprise a combination of at least two different colored yarns. One of the yarns of the fourth plurality of yarns can comprise a combination of at least two different colored yarns. The third plurality of yarns can comprise a yarn that is turquoise and a yarn that is a combination of green and brown yarn. The fourth plurality of yarns comprises a yarn that is brown and a yarn that is a combination of blue and yellow yarns.

The colors of the carpet tile can be within 20% of each other based on the Munsell value scale.

Any type of configuration using the same type or different types of tiles can be used to create a variety of appearances.

The carpet that contains the yarn pattern of the present invention can have any conventional construction and typically includes at least a primary backing that permits the tufting or bonding of the yarns into a pattern. The carpet can also include a secondary backing, a pre-coat layer located beneath the primary backing, and any number of intermediate layers, wherein the intermediate layers can include reinforcement or stabilizer layers such as fiberglass layers or other polymer layers such as PVC, polyurethane, polystyrene, foam layers, and the like. The foam layers can be any type of foam layer such as a foamed polyurethane layer, a polyvinylchloride foam layer, and the like. The carpet can be cushion backed or hard back. The materials used for each layer can be any conventional materials for instance as described in U.S. Pat. Nos. 6,497,936; 6,316,075; 6,397,544; 6,413,632; 5,545,276; 6,203,881; 5,204,155; 5,198,277; 6,089,007; 5,683,780; 5,030,497; 4,680,209; 4,629,642; 4,522,857; 4,347,273; 3,968,709; and 4,437,918, all incorporated in their entirety by reference herein. These patents also describe other aspects that can be used in the present invention. The carpet can also have an adhesive on the back of the carpet, such as a peel and stick carpet tile, for instance, using releasable adhesive. In forming the carpet and each layer, conventional methods of tufting the yarn using a tufting machine can be used.

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the specification and examples be considered as exemplary only, with a true scope and spirit of the present invention being indicated by the following claims and equivalents thereof.

What is claimed is:

1. A carpet tile comprising:
a backing;
a leading edge;
a trailing edge opposite the leading edge;
a length extending from the leading edge to the trailing edge and defined by the distance from the leading edge to the trailing edge;
a first plurality of sections, each section of the first plurality of sections having a width that is perpendicular to the length of the carpet tile and that is the same distance as the width of the other sections of the first plurality of sections, and each section having a length that is parallel to the length of the carpet tile and shorter than the length of the carpet tile, wherein, the first plurality of sections comprises
a first plurality of yarns, each yarn of the first plurality of yarns having a respective color scheme that differs from the color scheme of at least one of the other yarns of the first plurality of yarns, each yarn of the first plurality of yarns extending from the leading edge to the trailing edge, each yarn of the first plurality of yarns having a respective height, relative to the backing, that remains constant from the leading edge to the trailing edge, and
a second plurality of yarns, each yarn of the second plurality of yarns having a respective color scheme that differs from the color scheme of at least one of the other yarns of the second plurality of yarns, each yarn of the second plurality of yarns extending from the leading edge to the trailing edge, each yarn of the second plurality of yarns having two or more different heights, relative to the backing, from the leading edge to the trailing edge;
a second plurality of sections adjacent the first plurality of sections, each section of the second plurality of sections having a width that is perpendicular to the length of the carpet tile and that is the same distance as the width of the other sections of the second plurality of sections, and each section of the second plurality of sections having a length that is parallel to the length of the carpet tile and shorter than the length of the carpet tile, wherein the widths of the sections of the second plurality of sections is different from the widths of the sections of the first plurality of sections, wherein the second plurality of sections comprises
a third plurality of yarns, each yarn of the third plurality of yarns having a respective color scheme that differs from the color scheme of at least one of the other yarns of the third plurality of yarns, each yarn of the third plurality of yarns extending from the leading edge to the trailing edge, each yarn of the third plurality of yarns having a respective height, relative to the backing, that remains constant from the leading edge to the trailing edge; and
a fourth plurality of yarns, each yarn of the fourth plurality of yarns having a respective color scheme that differs from the color scheme of at least one of the other yarns of the fourth plurality of yarns, each yarn of the fourth plurality of yarns extending from the leading edge to the trailing edge, each yarn of the fourth plurality of yarns having two or more different heights, relative to the backing, from the leading edge to the trailing edge;
wherein two of the fourth plurality of yarns have the same color scheme as two of the first plurality of yarns; and
wherein each of the color schemes are within 20% of each other based on the Munsell scale.

2. A carpet tile comprising:
a backing;
a leading edge;
a trailing edge opposite the leading edge;
a length extending from the leading edge to the trailing edge and defined by the distance from the leading edge to the trailing edge; and
a first plurality of sections, each section of the first plurality of sections having a width that is perpendicular to the length of the carpet tile and that is the same distance as the width of the other sections of the first plurality of sections, and each section having a length that is parallel to the length of the carpet tile and shorter than the length of the carpet tile, wherein, the first plurality of sections comprises
a first plurality of yarns, each yarn of the first plurality of yarns having a respective color scheme that differs from the color scheme of at least one of the other yarns of the first plurality of yarns, each yarn of the first plurality of yarns extending from the leading edge to the trailing edge, each yarn of the first plurality of yarns having a respective height, relative to the backing, that remains constant from the leading edge to the trailing edge, and
a second plurality of yarns, each yarn of the second plurality of yarns having a respective color scheme that differs from the color scheme of at least one of the other yarns of the second plurality of yarns, each yarn of the second plurality of yarns extending from the leading edge to the trailing edge, each yarn of the second plurality of yarns having two or more different heights, relative to the backing, from the leading edge to the trailing edge.

3. The carpet tile of claim 2, wherein the first plurality of yarns comprises two different color schemes.

4. The carpet tile of claim 2, wherein the second plurality of yarns comprises two different color schemes.

5. The carpet tile of claim 2, flrther comprising a second plurality of sections adjacent the first plurality of sections, each section of the second plurality of sections having a width that is perpendicular to the length of the carpet tile and that is the same distance as the width of the other sections of the second plurality of sections, and each section of the second plurality of sections having a length that is parallel to the length of the carpet tile and shorter than the length of the carpet tile, wherein the widths of the sections of the second plurality of sections is different from the widths of the sections of the first plurality of sections.

6. The carpet tile of claim 5, wherein the second plurality of sections comprises:
a third plurality of yarns, each yarn of the third plurality of yarns having a respective color scheme that differs from the color scheme of at least one of the other yarns of the third plurality of yarns, each yarn of the third plurality of yarns extending from the leading edge to the trailing edge, each yarn of the third plurality of yarns having a respective height, relative to the backing, that remains constant from the leading edge to the trailing edge; and
a fourth plurality of yarns, each yarn of the fourth plurality of yarns having a respective color scheme that differs from the color scheme of at least one of the other yarns of the fourth plurality of yarns, each yarn of the fourth plurality of yarns extending from the leading edge to the trailing edge, each yarn of the fourth plurality of yarns having two or more different heights, relative to the backing, from the leading edge to the trailing edge.

7. The carpet tile of claim 6, wherein two of the fourth plurality of yarns have the same color scheme as two of the first plurality of yarns.

8. The carpet tile of claim 7, wherein two of the third plurality of yarns have the same color scheme as two of the second plurality of yarns.

9. The carpet tile of claim 6, wherein the width of the sections of the second plurality of sections is smaller than the width of the sections of the first plurality of sections.

10. The carpet tile of claim 5, wherein each section of the first plurality of sections and each section of the second plurality of sections comprises one rectangular shape.

11. The carpet tile of claim 2, wherein one of the yarns of the first plurality of yarns comprises a combination of at least two different colored yarns and one of the yarns of the second plurality of yarns comprises a combination of at least two different colored yarns.

12. The carpet tile of claim 11, wherein the first plurality of yarns comprises a yarn that is brown and a yarn that is a combination of blue and yellow yarns, and wherein the second plurality of yarns comprises a yarn that is turquoise and a yarn that is a combination of green and brown yarns.

13. The carpet tile of claim 6, wherein one of the yarns of the third plurality of yarns comprises a combination of at least two different colored yarns and one of the yarns of the fourth plurality of yarns comprises a combination of at least two different colored yarns.

14. The carpet tile of claim 13, wherein the third plurality of yarns comprises a yarn that is turquoise and a yarn that is a combination of green and brown yarns, and wherein the fourth plurality of yarns comprises a yarn that is brown and a yarn that is a combination of blue and yellow yarns.

15. The carpet tile of claim 6, wherein the colors of the carpet tile are within 20% of each other based on the Munsell value scale.

16. A floor covering comprising a plurality of the carpet tiles of claim 2 positioned side by side.

17. The floor covering of claim 16, wherein the tiles are assembled in random orientation.

18. The floor covering of claim 16, wherein each tile further comprises a second plurality of sections adjacent the first plurality of sections, each section of the second plurality of sections having a width that is perpendicular to the length of the carpet tile and that is the same distance as the width of the other sections of the second plurality of sections, and each section of the second plurality of sections having a length that is parallel to the length of the carpet tile and shorter than the length of the carpet tile, wherein the widths of the sections of the second plurality of sections is different from the widths of the sections of the first plurality of sections.

19. The floor covering of claim 18, wherein the second plurality of sections comprises:
a third plurality of yarns, each yarn of the third plurality of yarns having a respective color scheme that differs from the color scheme of at least one of the other yarns of the third plurality of yarns, each yarn of the third plurality of yarns extending from the leading edge to the trailing edge, each yarn of the third plurality of yarns having a respective height, relative to the backing, that remains constant from the leading edge to the trailing edge; and
a fourth plurality of yarns, each yarn of the fourth plurality of yarns having a respective color scheme that differs from the color scheme of at least one of the other yarns of the fourth plurality of yarns, each yarn of the fourth plurality of yarns extending from the leading edge to the trailing edge, each yarn of the fourth plurality of yarns having two or more different heights, relative to the backing, from the leading edge to the trailing edge.

20. A carpet tile comprising:
a backing;
a leading edge;
a trailing edge opposite the leading edge;
a length extending from the leading edge to the trailing edge and defined by the distance from the leading edge to the trailing edge;
a first plurality of sections, each section of the first plurality of sections having a width that is perpendicular to the length of the carpet tile and that is the same distance as the width of the other sections of the first plurality of sections, and each section having a length that is parallel to the length of the carpet tile and shorter than the length of the carpet tile, wherein, the first plurality of sections comprises
a first plurality of yarns, each yarn of the first plurality of yarns having a respective color scheme that optionally differs from the color scheme of at least one of the other yarns of the first plurality of yarns, each yarn of the first plurality of yarns extending from the leading edge to the trailing edge, each yarn of the first plurality of yarns having a respective height, relative to the backing, that remains constant from the leading edge to the trailing edge, and
a second plurality of yarns, each yarn of the second plurality of yarns having a respective color scheme that differs from the color scheme of at least one of the other yarns of the second plurality of yarns, each yarn of the second plurality of yarns extending from the leading edge to the trailing edge, each yarn of the second plurality of yarns having two or more different heights, relative to the backing, from the leading edge to the trailing edge;
a second plurality of sections adjacent the first plurality of sections, each section of the second plurality of sections having a width that is perpendicular to the length of the carpet tile and that is the same distance as the width of the other sections of the second plurality of sections, and each section of the second plurality of sections having a length that is parallel to the length of the carpet tile and shorter than the length of the carpet tile, wherein the widths of the sections of the second plurality of sections is different from the widths of the sections of the first plurality of sections, wherein the second plurality of sections comprises
a third plurality of yarns, each yarn of the third plurality of yarns having a respective color scheme that optionally differs from the color scheme of at least one of the other yarns of the third plurality of yarns, each yarn of the third plurality of yarns extending from the leading edge to the trailing edge, each yarn of the third plurality of yarns having a respective height, relative to the backing, that remains constant from the leading edge to the trailing edge; and
a fourth plurality of yarns, each yarn of the fourth plurality of yarns having a respective color scheme that differs from the color scheme of at least one of the other yarns of the fourth plurality of yarns, each yarn of the fourth plurality of yarns extending from the leading edge to the trailing edge, each yarn of the fourth plurality of yarns having two or more different heights, relative to the backing, from the leading edge to the trailing edge;
wherein two of the fourth plurality of yarns have the same color scheme as two of the first plurality of yarns; and
wherein each of the color schemes are optionally within 20% of each other based on the Munsell scale.
